(19) United States
(12) Patent Application Publication
(10) Pub. No.: US 2026/0320061 A1
(43) Pub. Date: Oct. 15, 2026

(54) USER ENGAGEMENT SCORING TO RE-RANK RESULTS

(71) Applicant: Dell Products L.P., Round Rock, TX (US)

(72) Inventors: Fatemeh Azmandian, Raynham, MA (US); Ananda D. Siddacharya, Shrewsbury, MA (US); Amihai Savir, Newton, MA (US); William Ferreira da Silva Filho, Hortolândia (BR)

(21) Appl. No.: 19/180,050

(22) Filed: Apr. 15, 2025

(51) Int. Cl. G06F 16/2457; G06F 16/3332; G06F 16/9035

(52) U.S. Cl. CPC G06F 16/24578; G06F 16/3334; G06F 16/9035

(57) ABSTRACT

A computing system may determine user engagement metrics corresponding to user action performed with respect to computing results presented by the computing system responsive to a prompt. The computing system may generate scores corresponding to the computing system based on the user engagement metrics. The computing system may apply weighting factors, corresponding to user engagement parameters with respect to which the user engagement metrics are determined, to the computing results. The computing system may apply a function, such as an averaging function, to the weighted computing results. The computing system may re-rank the computing results or may generate new computing results based on the weighted courage computing results. The computing system may present the re-ranked/new computing results to a user according to the re-ranking.

### BACKGROUND

The term ‘cloud’ may refer to a set, group, collection, or other plurality of computing resources, components, services, instances, collections, application, and the like that may be accessed by a computing resource, typically via a communication network (a communication network may also be referred to as a cloud). The term ‘cloud’ is typically used in reference to the computing resources without referencing specific items that make up the cloud resources when discussing computing functionality from the perspective of a computing resource that may make use of the functionality.

A cloud computing service provider may make available various computing resources, for example, software as a service, virtual machines, storage, bare metal computing hardware, or even a complete enterprise’s infrastructure and development platforms, over a communication network. A cloud services provider may make a public cloud computing resource available to users over a publicly accessible network, such as the Internet. A private cloud computing resource is typically available or accessible only by a given customer, such as an enterprise and its employees. Computing resources may be provided from an enterprise’s own on-premises data center or from a data center operated by an independent (e.g., independent from the enterprise customer) cloud services provider. A hybrid cloud may connect an organization's private cloud services and resources of public clouds into an infrastructure that facilitates the organization’s applications and workloads in a manner that balances the maximizing of performance and the minimizing of costs across public and private cloud computing resources.

Computing resources that make use of, that are based on, that facilitate, or that otherwise make available artificial intelligence learning models, for example language learning models or large learning models, may be facilitated by a single computing system, multiple computing systems, or cloud services computing systems that may be operated by a private entity or that may be provided by a public computing services entity for use by a private entity. Context information may be applied to a language learning model via input information that may be referred to as prompt information with respect to the language model.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise applying, by at least one computing system comprising at least one processor, at least one user engagement indication to at least one computing result to result in at least one computing result score corresponding to the at least one computing result, wherein the at least one user engagement indication corresponds to at least one action signal resulting from at least one action with respect to the at least one computing system and with respect to at least one of the at least one computing result. Based on the at least one computing result score, the method may further comprise ranking, by the at least one computing system, the at least one computing result.

In an example embodiment, the at least one computing result may comprise at least one search result.

In an example embodiment, The at least one action with respect to the at least one computing system may comprise a pausing, during at least one pause period, of motion by at least one user in response to the at least one computing result.

In an example embodiment, the at least one action with respect to the at least one computing system may comprise at least one motion caused by a user.

In an example embodiment, the at least one action signal may be generated by at least one peripheral device communicatively coupled to the at least one computing system.

In an example embodiment, the at least one action signal may be generated by at least one wearable device communicatively coupled to the at least one computing system. The at least one wearable device may comprise at least one extended reality device.

In an example embodiment, the at least one computing result may comprise, responsive to at least one prompt, at least one chat response generated by at least one learning model. The method may further comprise, based on the at least one computing result score, revising, by the at least one computing system, the at least one learning model.

In an example embodiment, the at least one computing result comprises at least one retrieval-augmented generation result.

In an example embodiment, the method may further comprise applying, by the at least one computing system, at least one weighting coefficient to the at least one of the at least one computing result score to result in at least one modified computing result score corresponding to each of the at least one of the at least one computing result. With respect to at least one of the at least one modified computing result score, the method may further comprise applying, by the at least one computing system, at least one function to the at least one of the at least one modified computing result score to result in at least one determined function result associated with the at least one of the at least one modified computing result score. The at least one computing result may be ranked according to the at least one determined function result.

In an example embodiment, the at least one function may comprise at least one average function. The at least one determined function result may comprise at least one average computing result score.

In an example embodiment, the at least one user engagement indication may correspond to at least one action signal resulting from multiple actions by multiple users with respect to the at least one computing system.

In another example embodiment, a computing system may comprise at least one processor configured to process executable instructions that, when executed by the at least one processor, may facilitate performance of operations that may comprise applying at least one user engagement indication to at least one computing result to result in at least one computing result score, wherein the at least one user engagement indication comprises at least one result of at least one action with respect to the computing system and with respect to at least one of the at least one computing result and applying at least one weighting coefficient to at least one of the at least one computing result score to result in at least one weighted computing result score corresponding to each of the at least one of the at least one computing result. With respect to at least one of the at least one weighted computing result score, the operations may further comprise applying at least one function to the at least one of the at least one weighted computing result score to result in at least one determined function result associated with the at least one of the at least one computing result score. The operations may further comprise ranking the at least one computing result according to the at least one determined function result.

In an example embodiment, the at least one computing result may comprise, responsive to at least one prompt, at least one chat response generated by at least one learning model.

In an example embodiment, the at least one chat response may correspond to multiple chat sessions that are active concurrently. Based on the ranking of the at least one computing result according to the at least one determined function result, the operations may further comprise training the at least one learning model during at least one of the multiple chat sessions.

In yet another example embodiment, a non-transitory machine-readable medium may comprise executable instructions that, when executed by at least one processor corresponding to at least one computing system, may facilitate performance of operations that may comprise applying at least one user engagement indication to at least one computing search result to result in at least one computing search result score, The at least one user engagement indication may be indicative of at least one engagement characteristic corresponding to interaction with the at least one computing system and with respect to at least one of the at least one computing search result. The operations may further comprise applying at least one weighting coefficient to at least one of the at least one computing search result score to result in at least one weighted computing search result score corresponding to each of the at least one of the at least one computing search result. With respect to at least one of the at least one weighted computing search result score, the operations may further comprise applying at least one average function to the at least one of the at least one weighted computing search result score to result in at least one determined function result associated with the at least one of the at least one weighted computing search result score. The operations may further comprise ranking the at least one computing search result according to the at least one determined function result.

In an example embodiment, the at least one computing search result may comprise at least one vector search result or at least one keyword search result. The at least one user engagement indication may comprise at least one vector user engagement indication and at least one keyword user engagement indication. The operations may further comprise based on the at least one vector user engagement indication, ranking the at least one vector search result to result in at least one ranked vector search result. Based on the at least one keyword user engagement indication, the operations may further comprise ranking the at least one keyword search result to result in at least one ranked keyword search result. The ranking the at least one computing search result may comprise performing at least one reciprocal rank fusion operation with respect to the at least one ranked vector search result and the at least one ranked keyword search result.

In an example embodiment, the at least one user engagement indication may correspond to multiple actions determined to have been taken by multiple users with respect to the at least one computing system. The at least one computing search result may be generated using at least one learning model. The at least one learning model may be revised based on the multiple actions.

### BRIEF DESCRIPTION OF THE DRAWINGS

FIG. 1 illustrates an example architecture to rank computing results using user engagement information.

FIG. 2 illustrates an example flow of ranking computing results using user engagement information.

FIG. 3 illustrates an example applying user engagement information to computing results to re-rank the computing results.

FIG. 4 illustrates example chat session results being re-ranked and presented to a user.

FIG. 5 illustrates an example wearable extended reality appliance.

FIG. 6 illustrates a flow diagram of an example method to rank, or re-rank, computing results using user engagement information.

FIG. 7 illustrates a block diagram of an example method.

FIG. 8 illustrates a block diagram of an example computing system.

FIG. 9 illustrates a block diagram of an example non-transitory machine-readable medium.

FIG. 10 illustrates a computer environment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

According to conventional techniques, a problem exists with providing computing results, for example search results or online chat session results, to a user. Artificial Intelligence (“AI”) chat session may be facilitated by context-aware, retrieval-augmented generation (“RAG”) AI model searches. Hybrid searching may combine results of semantic searches and keyword searches. However, current techniques do not capture and use real user engagement/interaction information, such as click through rates, views, time passage without user selection or response after a content item (e.g., a chat session response from a chat bot) has been provided, eye movement, or movement detected or determined by a virtual reality or extended reality appliance.

Not using user engagement information may result in decreased relevance and accuracy of computing results. Without real-time engagement data corresponding to a user with respect to chat results, for example, the chat results may not reflect the most current interests or intentions of the user, thus leading to less relevant responses from a chat bot. Not using user engagement information may result in missed personalization opportunities with respect to computing results. According to conventional techniques, difficulty exists with respect to gathering, and motivating users to provide, authentic user feedback.

Accordingly, example embodiments disclosed herein may solve problems existing with respect to conventional techniques of not refining computing results based on real time user engagement and interaction information corresponding to interaction by a user with a computing system and computing results determined by, provided by, or presented by, the computing system. Example embodiments disclosed herein may facilitate obtaining real-time user engagement feedback with little to no effort by a user. Example embodiments disclosed herein may facilitate re-ranking of computing results based on real time user engagement feedback, thus facilitating, dynamically with respect to time, adapting and providing computing results that may be personalized with respect to a user who may be interacting with the computing results via the computing system. Because user engagement feedback may be provided in real time according to example embodiments disclosed herein, delay in providing feedback according to conventional techniques (e.g., an after-the-fact survey or being based on results that may be selected by a user) may be reduced or eliminated, thus facilitating re-ranking computing results by the computing system, is some cases before the computing system provides one or more of the computing results to a user via a user interface.

According to embodiments disclosed herein, at least one user engagement indication may be generated by at least one computing system that corresponds to at least one action signal resulting from at least one action made by a user with respect to at least one computing result that may be provided to the user by the at least one computing system. The at least one computing system may apply the at least one user engagement indication, or information corresponding thereto, to computing results, which may be generated in response to a prompt or other input from the user, to facilitate re-ranking of the computing results which in turn may facilitate the most relevant of the computing results being presented to the user by the computing system before less relevant items of the computing results may be presented to the user.

According to example embodiments disclosed herein, real user monitoring (“RUM”) techniques may be used to facilitate and enhance results or responses presented by an AI chat bot. According to example embodiments disclosed herein RUM techniques may be used to facilitate generation of real time event log information corresponding user events/action, such as, for example, user clicks, hovers, time spent on specific content on iterative prompting / conversation chat, downloads, etc. After ingesting the log information, according to embodiments disclosed herein, the ingested user action log/information may be used to facilitate determining computing results scores, which may be relevancy scores, corresponding to how relevant, or important, a computing result may be to a user, and the user action information may be used to facilitate reranking of the computing results based on the user action information.

RUM techniques may be used to facilitate capturing real-time usage/activity logs corresponding to user actions taken with respect to a computing system via a user interface. According to example embodiments disclosed herein, RUM techniques may be used to collect real time user engagement information. After collecting the use logs, user activities may be determined based thereon that may be used to re-rank computing results, such as search results or chat bot session responses, by a re-ranking pipeline component.

At least one component, such as, for example, a custom webhook application programming interface (API) or a Kafka API, may be used to push engagement data to a unified analytics engine, such as, for example, Spark, using a real time streaming service, such as, for example, a Spark Streaming service. User action/interface engagement data may be broken down into manageable chunks using chucking strategy according to at least one embedding model.

RUM user engagement data may be ‘vectorized’ according to at least one embedding model. After engagement data chunking, each chunk may be converted into a vector format value, or a vector entry, to be usable for, for example, a similarity search using an embedding model, such as, for example, bge-m3, that can facilitate processing according to different granularities, including long documents, that may be as large as, or that may exceed, 8192 tokens.

A hybrid search may result in two ordered lists of relevant result chunks – one list corresponding to vector search (semantic similarity) results and the other list corresponding to keyword search (text-based similarity) results. For each list, a score may be assigned to each chunk based on real-time user engagement metrics. A weighted average of scores corresponding to a vector search result or keyword search result may be generated. A reverse rank fusion (“RRF”) may be used to combine weighted average search results corresponding to the two lists to result in a re-ranked chunks, which may be used to determine results to present to a user that may correspond to the RUM information or that may be a different user than a user that performed actions the resulted in the RUM information that was used to facilitate the re-ranking of computing results.

Unlike conventional techniques that may use factors like keyword matching and metadata to determine ranking of computing results, example embodiments disclosed herein may use real-time engagement signals, such as, for example, click through rate (“CTR”), time spent by a user with respect to a computing result, view counts, and the like, to dynamically adjust ranking of computing results. By using an AI model to tailor and rank computing results based on real time user engagement metrics, the results may be more useful to a user who may be interacting with the computing results via a user interface. According to example embodiments disclosed herein, a feedback loop may be used to fine tune a ranking model based on user engagement metrics, thus facilitating self-optimization over time without manual intervention. An AI service that may facilitate ranking of computing results may continuously learn from user interaction and may automatically enhance relevance of computing results with respect to future user action(s). Computing results may be ranked according to relevancy that may be based on at least one action performed by at least one user. To facilitate ranking of results according to relevancy that may be based on multiple users’ actions, multiple user metrics may be combined into a single metric corresponding to at least one user engagement parameter (e.g., CTR).

By basing ranking of computing results on at least one real time user engagement metric respectively corresponding to at least one real time user engagement parameter, multiple benefits with respect to conventional techniques of ranking computing results may be achieved. By using real time engaging signal information, search results/AI response results may be dynamically tailored to individual user preferences to result in a personalized experience that adapts as users interact with computing result content. Continuous fine tuning by ranking services based on actual user behavior may facilitate results being aligned with what one or more users may think is valuable, pertinent, or relevant to their needs, thus resulting in higher user satisfaction with respect to interacting with computing results. In addition, use of real-time user engagement data may facilitate an AI system in responding to shifting trends and user interests. As users interact differently over time, an AI model may adapt to changing interaction habits and actions by reranking computing results so that more relevant and current content results is/are presented to a user in an order according to relevance. Furthermore, re-ranking data chunks based on engagement data may lead to increased user interaction, which may increase accuracy and relevancy of real time user engagement metrics (e.g. CTR, dwell time, or overall engagement) themselves (e.g., due to more statistical samples). Using user engagement data to re-rank computing results may facilitate obtaining business insights that may help a business understand user preferences, trending topics, and high performing content.

Applying RUM techniques to reranking by a learning model may enhance personalization with respect to a user and may improve accuracy. Personalization may facilitate a learning model prioritizing responses that align with a user’s preferences or behavior. For example, if a user frequently clicks on technical documentation links, future responses may rank more detailed, technical responses/results higher than links to non-technical documents. A learning model may adapt to user context over time, thus tending to reduce ambiguity with respect to user queries and tending to increase accuracy of responses as user interactions increase.

Although using user engagement metrics to facilitate re-ranking of computing results may result in a ranking of results that may be customized with respect to a particular user, excessive reliance on personalization could bias a learning model toward a specific user's preferences, which could potentially lower the relevance of responses to other users, or even with respect to the user if, for example, the user is seeking different information, or if the user is seeking information in a different way, than normal with respect to the user information that is different. Accordingly, to attempt to achieve a balance in re-ranking or computing results, RUM metric data corresponding to a particular user may be combined with universal engagement metrics (e.g., metrics corresponding to at least one parameter that have been obtained from, or determined with respect to, a large number of users) to maintain overall system accuracy or general usefulness that could be compromised by re-ranking entirely based on the effects of personalization with respect to a single user.

According to example embodiments disclosed herein, if two users (e.g., user A and use B) submit the same query or prompt but have different engagement patterns (e.g., user A and user B have different click through rate metrics and different time spent metrics), different computing results may be presented to user A than may be presented to user B according to example embodiments disclosed herein. Different results may be presented to user A than may be presented to user B if user A’s engagement history indicates a preference for detailed answers, leading a language learning model (“LLM”) to prioritize long-form or highly specific responses to be present to user A, whereas user B’s engagement history might indicate that user B favors concise summaries, thus causing the LLM to rank shorter, broader responses higher for presentation with respect to user B. A reranking method corresponding to the LLM may be automatically adjusted based on past interactions and behaviors. Thus, even if two input prompts/queries are identical, the output may be tailored to match each user’s historical preferences.

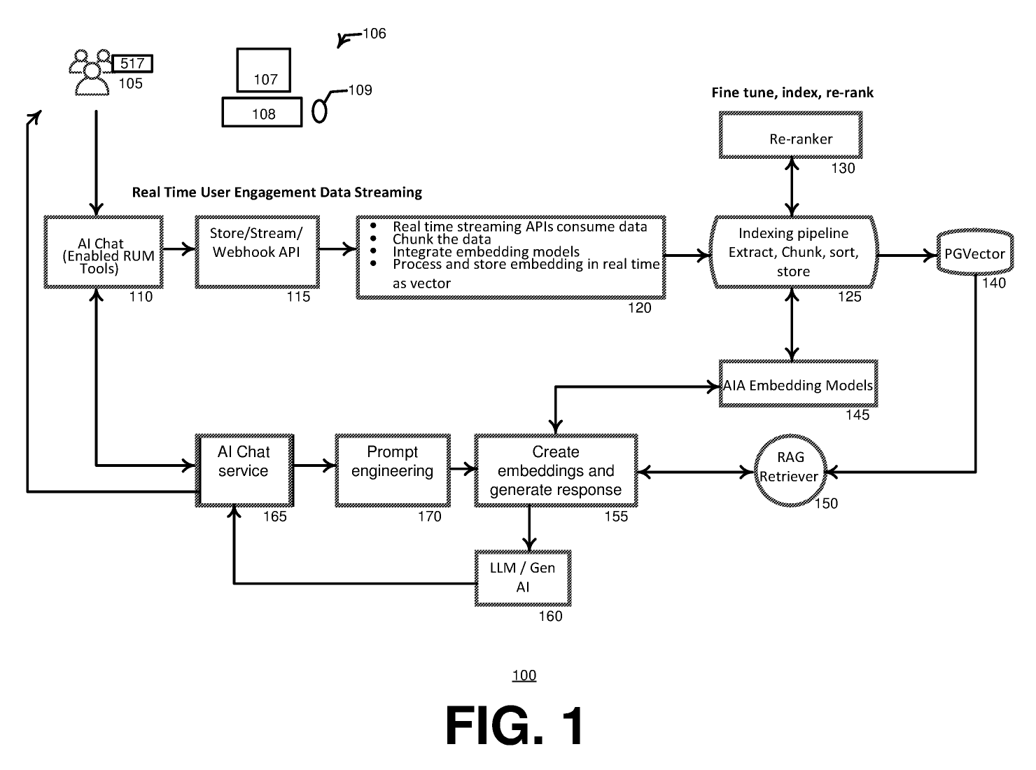

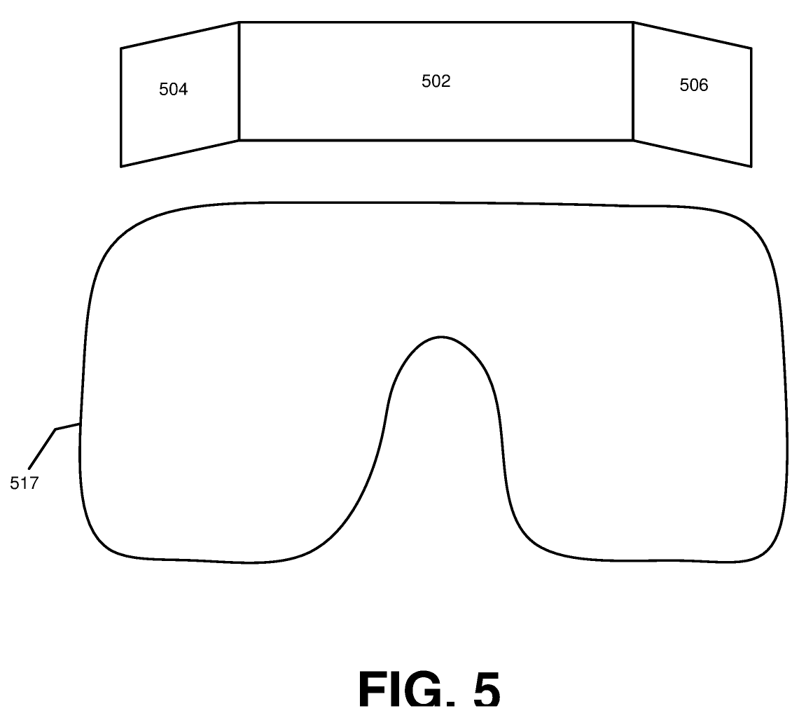

Turning now to FIG. 1, the figure illustrates components of a computing system 100. The components may comprise executable programs, processes, services, databases, and other computing items. At least one user 105 may interact with a user interface 106, which may comprise one or more peripheral devices, such as, for example, monitor/screen 107, keyboard/keypad 108, tracking device 109, such as, for example, a mouse, or a wearable device, such as, for example, virtual reality/extended reality appliance 517 described in reference to FIG. 5. It will be appreciated that components of user interface 106 may be combined into a single device, for example the components may be assembled into a smartphone, or items of the user interface may be separate components, for example, components of a personal computer or other type of computing device or system.

In an example embodiment, user 105 may interact with user interface 106. For example, user 105 may provide a prompt by typing terms using keyboard 108, or by speaking into a microphone, which is not shown in the figures but which may also be a component of user interface 106. An AI service 165, for example a search engine service or a chat service, may provide computing results responsive to at least one prompt entered via user interface 106 by user 105. User 105 may perform at least one action responsive to at least one computing result provided via user interface 106. For example, user 105 may view computing results, which may comprise at least one search result or which may comprise at least one response to a chatbot query, via monitor 107 or appliance 517. In another example, at least one user 105 may enter a response to a chat bot computing result with a further query or prompt via keyboard 108 or by clicking or selecting information via the keyboard or via mouse 109. (It will be appreciated that monitor 107 may comprise a touch screen and functionality corresponding to keyboard 108 and mouse 109 may be facilitated by the touch screen.)

RUM service 110 may capture and analyze signals corresponding to, or indicative of, actions that may or may not be taken by user 105 in response to computing results that may be generated by chat service 165. RUM techniques may be used to capture user interactivity by passively collecting data on how users interact with a website or an application in real-time. RUM service 110 may inject small scripts into web pages to monitor events such as page load times, user clicks, navigation paths, input field interactions, and errors. Such measured data, or metrics, may facilitate identifying computing bottlenecks and may facilitate optimizing a user’s experience based on actual behavior corresponding to the user rather than trying to use simulated interactions and using simulated interaction information to attempt to improve a user’s user experience. By capturing end-user actions, RUM provides actionable insights into application responsiveness, usability, and potential issues affecting user engagement. RUM can capture a wide range of user actions to provide comprehensive insights into user interactions with web applications or websites, including, for example, page load times, navigation paths, clicks, taps, form submissions, scrolling behavior, and hover events. RUM techniques may also facilitate tracking of dynamic content rendering, such as when elements appear due to user interactions, API call response times, and JavaScript errors that might occur during a computing session, for example during a chat bot customer service session. Additionally, RUM techniques may facilitate capturing detailed timing metrics such as First Contentful Paint and Time to Interactive metrics, which may be helpful in identifying performance bottlenecks and understanding user engagement patterns in real time.

At least one user engagement indication corresponding to at least one action performed by user 105 may be applied to at least one computing result (e.g., at least one chat bot response), to result in at least one computing result score corresponding to the at least one computing result. Based on the at least one computing result score, which may correspond to the computing results, the computing results, which may be generated by language learning model 160, may be ranked or re-ranked with respect to a previous ranking operation. Service 110 may collect real time user engagement with interface 106 and corresponding to actions by user 105 detected by interface 106 and may feed back signals corresponding to, or indications indicative of, the actions, via application programming interface (“API”) 115, such as, for example, a Kafka API, to streaming service 120. Actions that may be monitored and that may result in user engagement signals may comprise click through rates, views, thumbs up/down, additional feedback, views, time spent while a computing result is active/displayed, and the like, which may be referred to as user engagement parameters.

Service 120 may comprise at least one real-time ingestion API, such as, for example, a Spark API. Service 120 may process incoming engagement data received from API 115, parse the engagement data, convert the engagement data into ‘chunks’, and apply, or embed, the chunks of engagement data respectively with respect to the computing result(s), or chunks corresponding thereto, to which the engagement corresponds (e.g., user engagement/interaction data chucks may be applied to computing results with respect to which the engagement/interaction/user action(s) correspond(s)) to result in at least one vector (e.g., multiple values corresponding to multiple data chunks). Weighting factors may be applied, via, for example, matrix multiplication techniques, to the at least one vector. The weighting factors may be determined by an AI service, or the weighting factors may be input by user 105. The weighting factors may be received from a computing application or from training data that may be used to train a learning model. The extracting of RUM metric values, separating the metrics into chucks corresponding to computing results, and the computing results themselves, may be performed by, or received by, indexing pipeline 125.

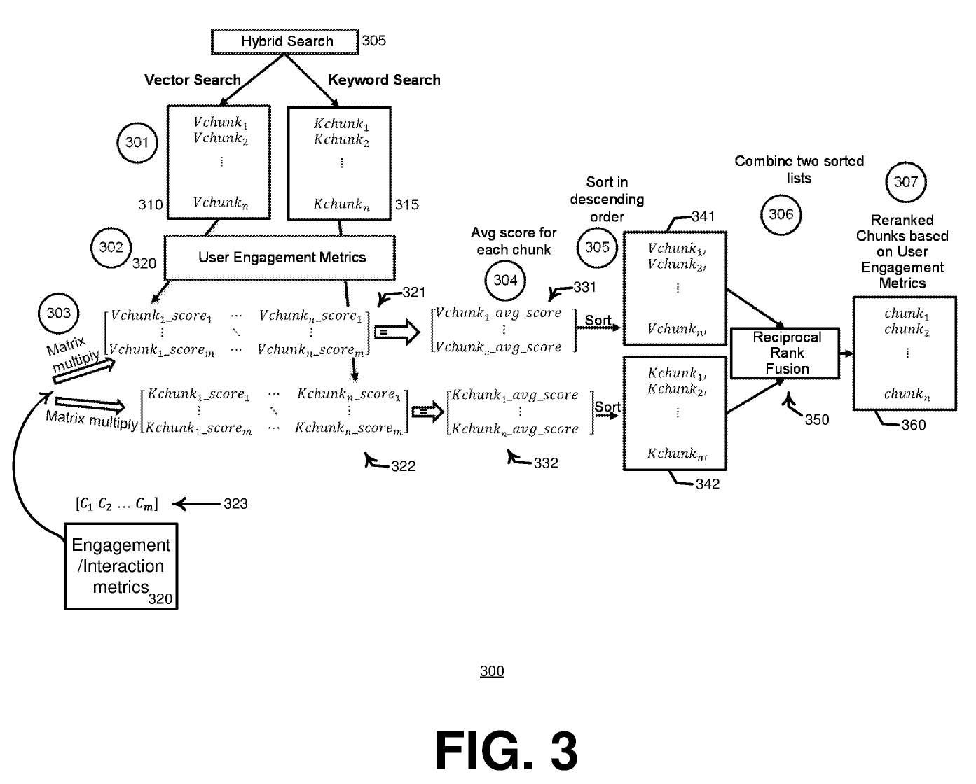

Indexing pipeline 125 may perform fine tuning and re-ranking of computing results. To generate computing results, for example search results or responses to chat bot queries/prompts, a hybrid search 305 as shown in FIG. 3 may be performed that may result in vector search result 310 and keyword search result 315 at step 301. Results 310 and 315 may comprise chunks of computing result data. At act 302, at least one user engagement metric 320, (e.g., at least one user engagement indication) may be applied to, or appended to, vector values corresponding to results 310 and 315 at act 302 to result in, respectively, vector search matrix 321 and keyword search matrix 322. Engagement metrics 320 may correspond to different user engagement parameters. For each value in matrix 321 or 322, at act 303 weighting factors 323 may be applied (e.g., via vector/matrix multiplication) to each chunk value of each of result 310 or 315 according to parameters metrics 320, or scores, with respect to user engagement parameters, with which the parameter metrics respectively correspond, to result in at least one vector search weighted average matrix 331 or at least one keyword search weighted average matrix 332 at act 304. At act 305, matrices 331 or 332 may be sorted to result in at least one sorted vector search weighted average matrix 341 or at least one sorted keyword search weighted average matrix 342. At act 306, at least one of matrix 341 and at least one matrix 342 may be combined using, for example, reverse rank fusion to produce at act 307 a final re-ranking 360 of computing result data chunks (e.g., a re-ranking of search results or chat bot responses that may be provided to a user in response to a query/prompt. Continuing with description of FIG. 1, re-ranker component 130 and vector component 140 may facilitate pipeline 125 generating re-ranking of computing results. Prompt engineering component 170 may receive output from AI service 165 to generate prompts based on output of AI service 165. Embedding component 155 may receive prompts from prompt engineering component 179 and RAG information from RAG receiver 150 to provide output to LLM 160 to result in updated computing results in some embodiments. Embedding models 145 may be used to inform pipeline 125 of computing results with respect to which RUM engagement metrics correspond, which may facilitate pipeline 125 ‘knowing’ which one of at least one computing result at least one RUM engagement metric corresponds.

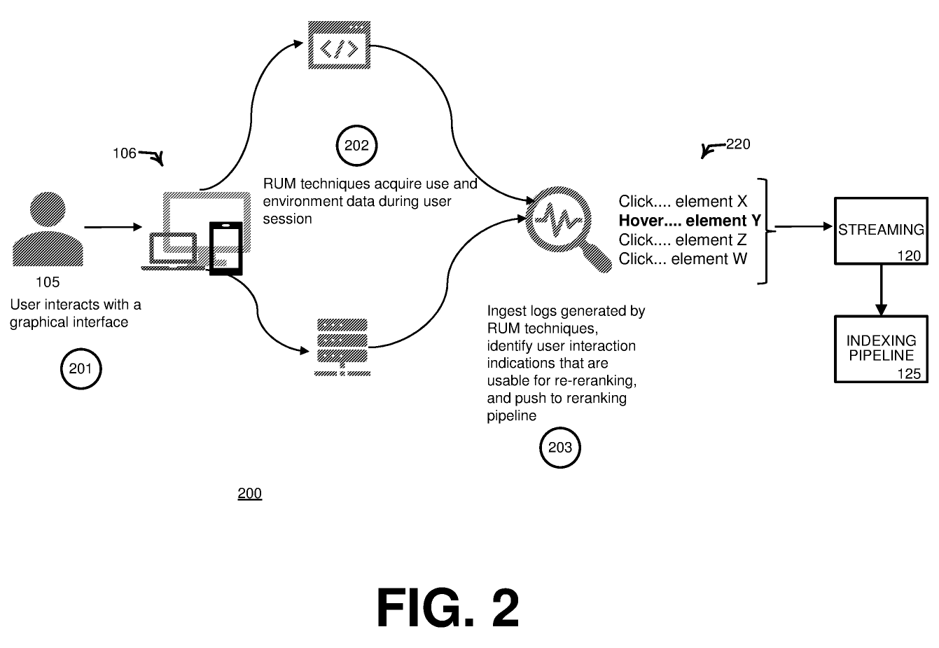

Turning now to FIG. 2, the figure illustrates an example flow of ranking computing results using user engagement information. At act 201, user 105 may interact with graphical user interface 106, which may be provided by, or facilitated by, a computing system comprising at least one processor. Interaction with user interface 106 by user 105 may comprise performing actions that may be represented by user engagement metrics corresponding to user engagement parameters. User engagement metrics may be referred to as user engagement indications. User engagement indications may be used to determine computing result scores corresponding to computing results that may be presented by user interface 106 to user 105 and with respect to which the user may interact, thus resulting in the user engagement metrics associated with the interaction(s). At act 202, a computing system, which may be a computing system that facilitates user interface 106 or which may be at least one different computing system than a computing system that facilitates the user interface, may acquire or determine the user engagement metrics based on interaction by user 105 with computing results presented to the user via user interface 106. At act 203, the at least one computing system may ingest log information, which may comprise user engagement metric information 220 corresponding to interaction by user 105 via user interface 106 with computing results. The at least one computing system may provide user engagement metric information 220 to streaming service 120 which may facilitate delivering user engagement metrics 220 to indexing pipeline 125 as described in reference to FIG. 1.

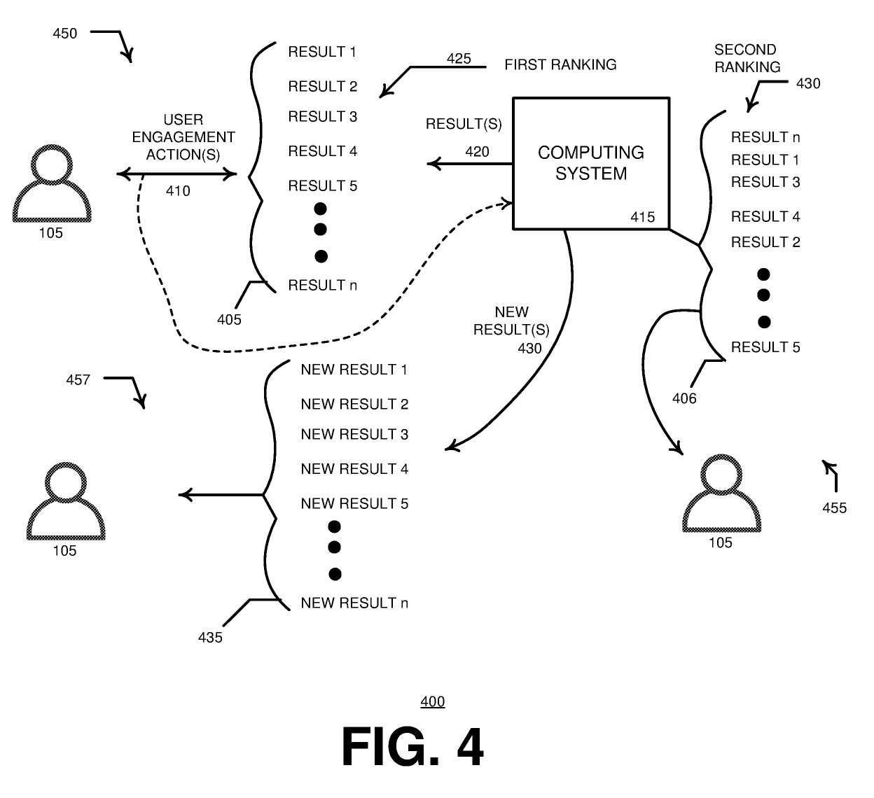

Turning now to FIG. 4, the figure illustrates example embodiment chat session results being re-ranked and presented to a user according to a new ranking order. Results 420 may be generated by computing system 415 in response to a query, or prompt, input to the computing system by user 105. Computing system 415 may rank results 420 according to a first ranking 425. User 105 may perform user engagement actions 410 according to a presentation order that may correspond to first ranking 425. In an example embodiment, during user session 450, results 420 may be presented to user 105 one at a time, or more than one result 420 may be simultaneously presented to the user according to order 405. For example, if Result 1 is presented to user 105 first during session 450, Result 2 may not be presented, if at all, to the user until after the user performs at least one user engagement action 410 with respect to Result 1. In an example embodiment, user engagement indications 410 determined by computing system 415 during session 420 may be used to re-rank Results 420 from first ranking 425 to result in second ranking 430, which may comprise the results 420 in a different order 406 as compared to order 405. During session 455, which may be subsequent to section 450, computing system 415 may present results 420 to user 105 according to order 406 corresponding to second ranking 430. In an example embodiment, computing system 415 may apply user engagement indications corresponding to user engagement actions 410 to results 420 to generate new results 430, which may be presented to user 105 during session 457. Session 457 may be a subsequent session with respect to session 455 or 450. Accordingly, user engagement indications corresponding to user engagement actions 410 performed by user 105 during session 450 may be used to re-rank results 420 for presentation during session 450 or for presentation during subsequent session 455 and the user engagement actions may also be used to by computing system 415 to generate new results 430 for presentation to user 105, either during session 450 or during subsequent session 457.

Turning now to FIG. 5, the figure illustrates a virtual reality (“VR”) application system 500. In system 500, wearable VR appliance 517 is shown from a wearer’s, or viewer’s, perspective. VR appliance 517 may comprise a center, or pose, visual display portion 502, a left visual display portion 504 and a right visual display portion 506, that may be used to display main visual information, left peripheral visual information, and right peripheral visual information, respectively. As shown in FIG. 5, portions 502, 504, and 506 are delineated by distinct lines, but it will be appreciated that hardware or software may facilitate gradual transition from main and peripheral information display. Appliance 517 may generate signals comprising information indicative of movement or manipulation of the appliance, which may be caused by a user of the appliance. Such movement or manipulation may be referred to as haptic movement or manipulation. A haptic movement or manipulation experienced by an appliance 517 may be referred to as a haptic experience. At least one haptic experience may correspond to at least one action signal that may result in, or cause to be generated, at least one user engagement indication, and may result from at least one action performed by at least one user, wearing appliance 517, with respect to the at least one computing system and with respect to at least one computing result, such as, for example, at least one search result or at least one chat session response.

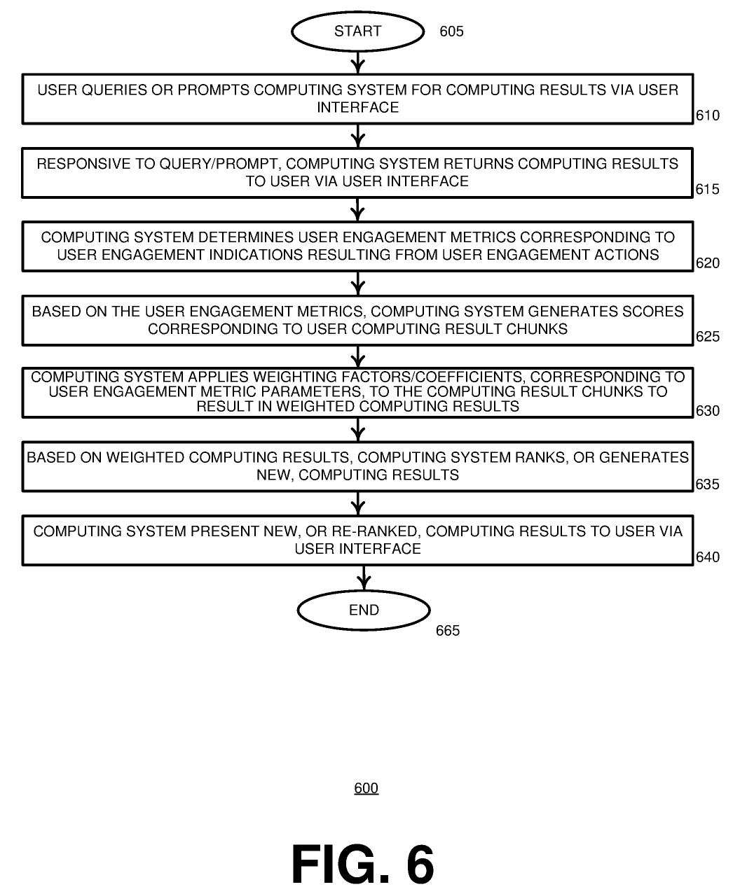

FIG. 6 illustrates a flow diagram of an example embodiment method 600. Method 600 begins at act 605. At act 610, a user may request result content from a computing system. In response to the request made by the user at act 610, at act 615 the computing system may generate at least one computing result corresponding to the request. The computing system may return and present the at least one computing result to the user via a user interface. At act 620, the computing system may determine user engagement metrics corresponding to user engagement indications resulting from user engagement actions. The user engagement actions may comprise actions performed by the user with respect to the user interface and with respect to the at least one computing result. For example, a user engagement metric may comprise an amount of time that passes after the computing system presents the at least one computing result for the user interface. Another user engagement metric may comprise a click through rate corresponding to at least one of the at least one computing result. Another user engagement metric may comprise eye movement of the user with respect to the at least one computing result wherein the eye movement may be detected or determined by a wearable appliance, such as, for example, extended reality appliance 517 described in reference to FIG. 5.

At act 625, based on at least one user engagement metric determined that act 620, the computing system may generate scores corresponding to the at least one computing result. For example, the computing system may divide the at least one computing result into at least one result chunk. At least one user engagement metric may be applied to the at least one result chunk to result in at least one result chunk score, or at least one scored result chunk. At act 630, the computing system may apply weighting factors, or coefficients, corresponding to user engagement metric parameters, with respect to which the at least one user engagement metric may correspond, to the at least one score result chunk to result in at least one weighted score result chunk. At act 635, the computing system, based on the at least one weighted score result chunk, may generate new result information for presentation to the user. For example, the new result information generated at act 635 may comprise a re-ranking of computing result returns to the user at act 615. In an example embodiment, the new result information generated at act 635 may comprise new results, for example new search results or new content information responsive to a prompt or query received via the user interface. It will be appreciated that a re-ranking of computing results, or the generation of new/different results altogether, may be presented to the user during a session that the user queried or prompted the computing system at act 610, or a re-ranking of computing results, or generation of new/different results, may be presented to the user, or another user, during a session that is different from a session with respect to which the user queried or prompted the computing system at acts 610. At act 640, the computing system may present the new/different, or reranked, computing results via the user interface and method 600 advances to act 665 and ends. It will be appreciated that presenting of computing results at act 615 or reranked/new/different results at act 640 may comprise presenting all computing results, fewer than all computing results, or just one computing result.

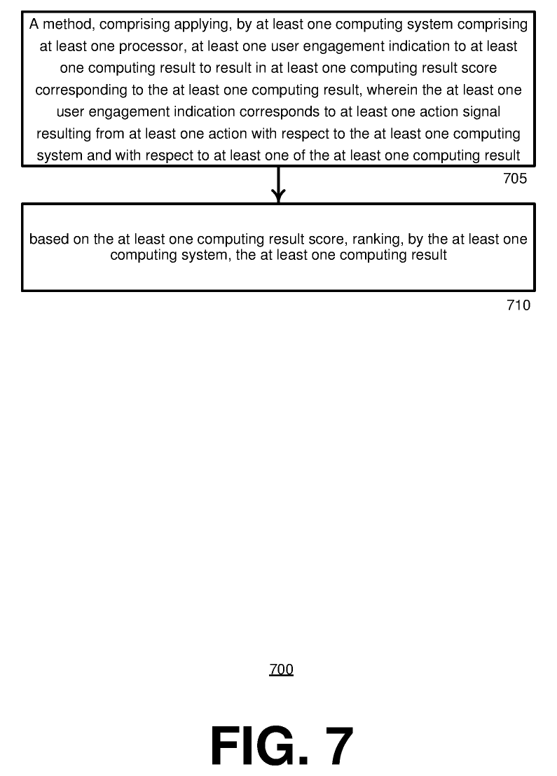

Turning now to FIG. 7, the figure illustrates an example method 700 comprising at block 705, applying, by at least one computing system comprising at least one processor, at least one user engagement indication to at least one computing result to result in at least one computing result score corresponding to the at least one computing result, wherein the at least one user engagement indication corresponds to at least one action signal resulting from at least one action with respect to the at least one computing system and with respect to at least one of the at least one computing result; and at block 710, based on the at least one computing result score, ranking, by the at least one computing system, the at least one computing result.

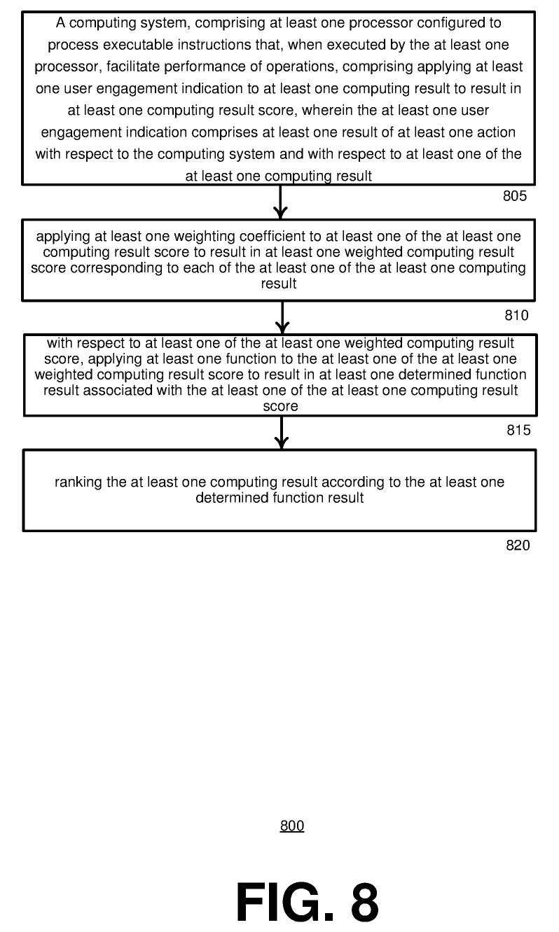

Turning now to FIG. 8, the figure illustrates an example computing system 800, comprising at block 805 at least one processor configured to process executable instructions that, when executed by the at least one processor, facilitate performance of operations, comprising, applying at least one user engagement indication to at least one computing result to result in at least one computing result score, wherein the at least one user engagement indication comprises at least one result of at least one action with respect to the computing system and with respect to at least one of the at least one computing result; at block 810 applying at least one weighting coefficient to at least one of the at least one computing result score to result in at least one weighted computing result score corresponding to each of the at least one of the at least one computing result; at block 815 with respect to at least one of the at least one weighted computing result score, applying at least one function to the at least one of the at least one weighted computing result score to result in at least one determined function result associated with the at least one of the at least one computing result score; and at block 820 ranking the at least one computing result according to the at least one determined function result.

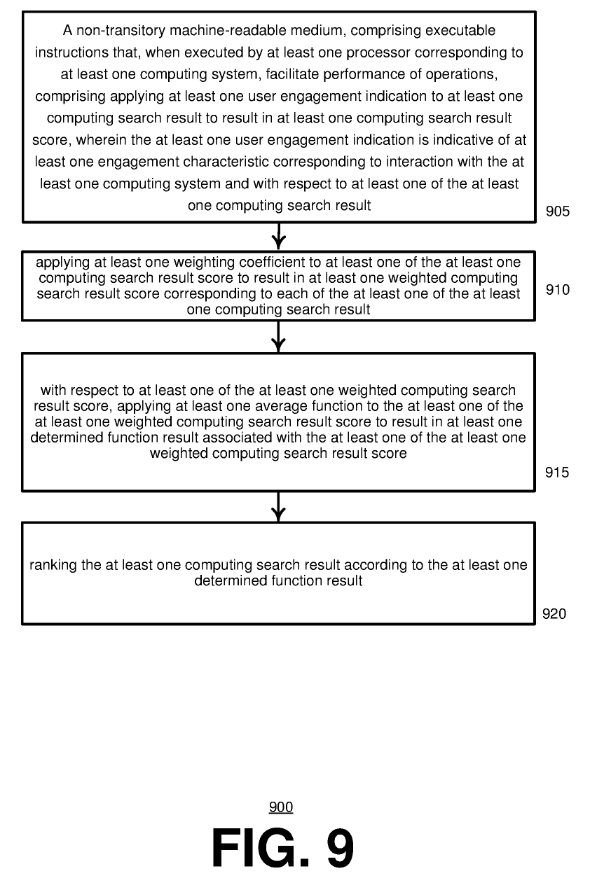

Turning now to FIG. 9, the figure illustrates non-transitory machine-readable medium 900, comprising at block 905 executable instructions that, when executed by at least one processor corresponding to at least one computing system, facilitate performance of operations, comprising, applying at least one user engagement indication to at least one computing search result to result in at least one computing search result score, wherein the at least one user engagement indication is indicative of at least one engagement characteristic corresponding to interaction with the at least one computing system and with respect to at least one of the at least one computing search result; at block 910 applying at least one weighting coefficient to at least one of the at least one computing search result score to result in at least one weighted computing search result score corresponding to each of the at least one of the at least one computing search result; at block 915 with respect to at least one of the at least one weighted computing search result score, applying at least one average function to the at least one of the at least one weighted computing search result score to result in at least one determined function result associated with the at least one of the at least one weighted computing search result score; and at block 920 ranking the at least one computing search result according to the at least one determined function result.

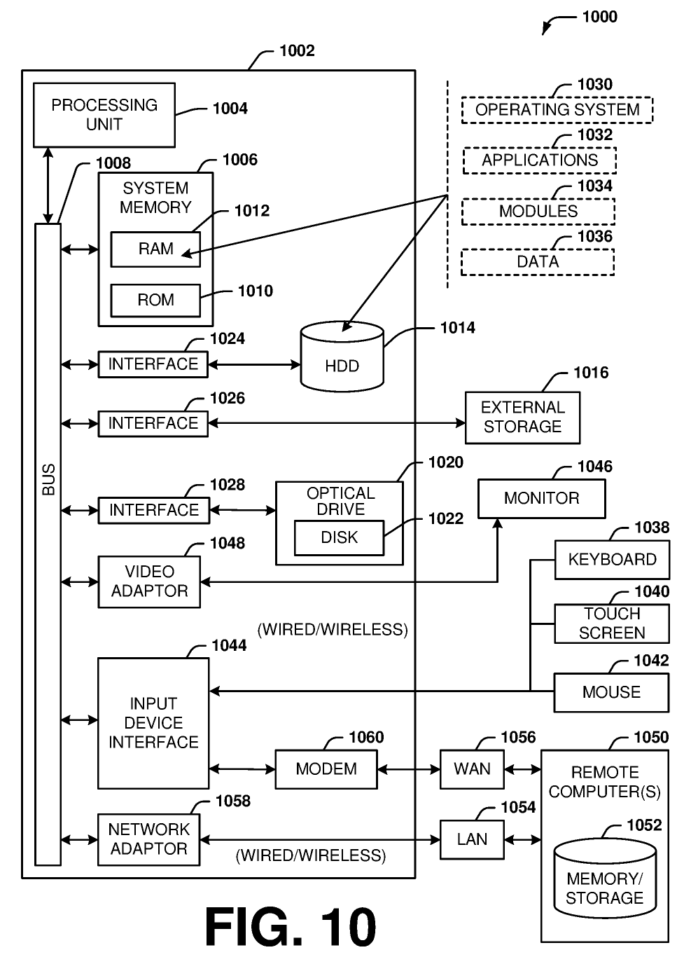

In order to provide additional context for various embodiments described herein, FIG. 10 and the following discussion are intended to provide a brief, general description of a suitable computing environment 1000 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

Computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance, with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The terms “first,” “second,” “third,” and so forth, as used in the claims, unless otherwise clear by context, is for clarity only and doesn’t otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
applying, by at least one computing system comprising at least one processor, at least one user engagement indication to at least one computing result to result in at least one computing result score corresponding to the at least one computing result, wherein the at least one user engagement indication corresponds to at least one action signal resulting from at least one action with respect to the at least one computing system and with respect to at least one of the at least one computing result; and
based on the at least one computing result score, ranking, by the at least one computing system, the at least one computing result.

2. The method of claim 1, wherein the at least one computing result comprises at least one search result.

3. The method of claim 1, wherein the at least one action with respect to the at least one computing system comprises a pausing, during at least one pause period, of motion by at least one user in response to the at least one computing result.

4. The method of claim 1, wherein the at least one action with respect to the at least one computing system comprises at least one motion caused by a user.

5. The method of claim 1, wherein the at least one action signal is generated by at least one peripheral device communicatively coupled to the at least one computing system.

6. The method of claim 1, wherein the at least one action signal is generated by at least one wearable device communicatively coupled to the at least one computing system.

7. The method of claim 6, wherein the at least one wearable device comprises at least one extended reality device.

8. The method of claim 1, wherein the at least one computing result comprises, responsive to at least one prompt, at least one chat response generated by at least one learning model.

9. The method of claim 8, further comprising:
based on the at least one computing result score, revising, by the at least one computing system, the at least one learning model.

10. The method of claim 1, wherein the at least one computing result comprises at least one retrieval-augmented generation result.

11. The method of claim 1, further comprising:
applying, by the at least one computing system, at least one weighting coefficient to the at least one of the at least one computing result score to result in at least one modified computing result score corresponding to each of the at least one of the at least one computing result; and
with respect to at least one of the at least one modified computing result score, applying, by the at least one computing system, at least one function to the at least one of the at least one modified computing result score to result in at least one determined function result associated with the at least one of the at least one modified computing result score,
wherein the at least one computing result is ranked according to the at least one determined function result.

12. The method of claim 11, wherein the at least one function comprises at least one average function, and wherein the at least one determined function result comprises at least one average computing result score.

13. The method of claim 1, wherein the at least one user engagement indication corresponds to at least one action signal resulting from multiple actions by multiple users with respect to the at least one computing system.

14. A computing system, comprising at least one processor configured to process executable instructions that, when executed by the at least one processor, facilitate performance of operations, comprising:
applying at least one user engagement indication to at least one computing result to result in at least one computing result score, wherein the at least one user engagement indication comprises at least one result of at least one action with respect to the computing system and with respect to at least one of the at least one computing result;
applying at least one weighting coefficient to at least one of the at least one computing result score to result in at least one weighted computing result score corresponding to each of the at least one of the at least one computing result;
with respect to at least one of the at least one weighted computing result score, applying at least one function to the at least one of the at least one weighted computing result score to result in at least one determined function result associated with the at least one of the at least one computing result score; and
ranking the at least one computing result according to the at least one determined function result.

15. The computing system of claim 14, wherein the at least one computing result comprises, responsive to at least one prompt, at least one chat response generated by at least one learning model.

16. The computing system of claim 15, wherein the at least one chat response corresponds to multiple chat sessions that are active concurrently, and wherein the operations further comprise:
based on the ranking of the at least one computing result according to the at least one determined function result, training the at least one learning model during at least one of the multiple chat sessions.

17. A non-transitory machine-readable medium, comprising executable instructions that, when executed by at least one processor corresponding to at least one computing system, facilitate performance of operations, comprising:
applying at least one user engagement indication to at least one computing search result to result in at least one computing search result score, wherein the at least one user engagement indication is indicative of at least one engagement characteristic corresponding to interaction with the at least one computing system and with respect to at least one of the at least one computing search result;
applying at least one weighting coefficient to at least one of the at least one computing search result score to result in at least one weighted computing search result score corresponding to each of the at least one of the at least one computing search result;
with respect to at least one of the at least one weighted computing search result score, applying at least one average function to the at least one of the at least one weighted computing search result score to result in at least one determined function result associated with the at least one of the at least one weighted computing search result score; and
ranking the at least one computing search result according to the at least one determined function result.

18. The non-transitory machine-readable medium of claim 17, wherein the at least one computing search result comprises at least one vector search result or at least one keyword search result, wherein the at least one user engagement indication comprises at least one vector user engagement indication and at least one keyword user engagement indication, and wherein the operations further comprise:
based on the at least one vector user engagement indication, ranking the at least one vector search result to result in at least one ranked vector search result; and
based on the at least one keyword user engagement indication, ranking the at least one keyword search result to result in at least one ranked keyword search result,
wherein the ranking the at least one computing search result comprises performing at least one reciprocal rank fusion operation with respect to the at least one ranked vector search result and the at least one ranked keyword search result.

19. The non-transitory machine-readable medium of claim 17, wherein the at least one user engagement indication corresponds to multiple actions determined to have been taken by multiple users with respect to the at least one computing system.

20. The non-transitory machine-readable medium of claim 19, wherein the at least one computing search result is generated using at least one learning model, and wherein the at least one learning model is revised based on the multiple actions.
